(19) United States
(12) Patent Application Publication
(10) Pub. No.: US 2012/0086895 A1
(43) Pub. Date: Apr. 12, 2012

(54) Display substrate and display device including the same

(76) Inventors: Sang-Hun Lee, Suwon-si (KR); Gwan-Soo Kim, Asan-si (KR); Yui-Ku Lee, Asan-si (KR); Se-Ah Kwon, Seoul (KR)

(21) Appl. No.: 13/065,970

(22) Filed: Apr. 4, 2011

(30) Foreign Application Priority Data
Oct. 7, 2010 (KR) 10-2010-0097811

(51) Int. Cl. G02F 1/1335; G02F 1/1339

(52) U.S. Cl. 349/106

(57) ABSTRACT

A liquid crystal display device with improved display quality is provided. The liquid crystal display device includes a signal line formed on a first substrate to extend generally in a first direction, a color filter at least partially overlapping the signal line, a black matrix pattern separated from the color filters by a separation region, and a column spacer pattern formed on the separation region.

### CROSS-REFERENCE TO RELATED APPLICATION

This application claims priority from Korean Patent Application No. 10-2010-0097811 filed on Oct. 7, 2010 in the Korean Intellectual Property Office, and all the benefits accruing therefrom under 35 U.S.C. 119, the contents of which in its entirety are herein incorporated by reference.

### BACKGROUND

1. Field of the Invention

The present invention relates to a liquid crystal display device, and more particularly to a liquid crystal display device with color filters separated from a black matrix pattern on signal lines.

2. Description of the Related Art

A liquid crystal display (LCD) is one type of flat panel display (FPD) that has seen wide acceptance in recent years. The liquid crystal display typically includes two substrates having electrodes, and a liquid crystal layer interposed between the two substrates. A voltage is applied to the electrodes to realign liquid crystal molecules of the liquid crystal layer, to thereby regulate the transmittance of light passing through the liquid crystal layer and thus generate images.

One of the two substrates of the liquid crystal display is typically a thin film transistor array substrate that includes a plurality of thin film transistors and pixel electrodes. Of recent interest is a structure in which color filters and a black matrix pattern are formed on the thin-film transistor array substrate in order to improve planarization characteristics, optical characteristics and alignment of the liquid crystal display.

However, when the color filters and the black matrix pattern are formed to overlap each other on signal lines, that portion of the substrate becomes excessively thick (i.e., the height of the corresponding region becomes too large). Accordingly, it is difficult to appropriately ensure a margin of liquid crystal injection.

### SUMMARY

The present invention provides a liquid crystal display device having improved display quality.

The objects of the present invention are not limited thereto, and the other objects of the present invention will be described in or be apparent from the following description of the embodiments.

According to an aspect of the present invention, there is provided a liquid crystal display device including a signal line formed on a first substrate to extend generally in a first direction, a color filter at least partially overlapping the signal line, a black matrix pattern separated from the color filter by a separation region, and a column spacer pattern formed on the separation region.

The other aspects of the present invention are included in the detailed description and drawings.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram showing a display device in accordance with embodiments of the present invention;

FIG. 2 illustrates an equivalent circuit diagram of a pixel used in a display substrate in accordance with an embodiment of the present invention;

FIG. 3 illustrates a layout for explaining a liquid crystal display device in accordance with the embodiment of the present invention;

FIG. 4 shows a partially enlarged view for explaining an arrangement relationship between a black matrix pattern and color filters of FIG. 3;

FIG. 5 is a cross sectional view taken along lines A-A′ and B-B′ of FIG. 4;

FIG. 6 illustrates a graph and diagram for explaining a height profile in a conventional structure; and

FIG. 7 illustrates a graph and diagram for explaining a height profile in a structure in accordance with the embodiment of the present invention.

### DETAILED DESCRIPTION OF THE EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Throughout the specification, like reference numerals in the drawings denote like elements.

It will be understood that when an element or a layer is referred to as being “on” or “connected to” another element or layer, it can be directly on or directly connected to the other element, or intervening elements may also be present. In contrast, when an element is referred to as being “directly on” or “directly connected to” another element, there are no intervening elements present. Like numbers refer to like elements throughout. As used herein, the term “and/or” includes any and all combinations of one or more of the associated listed items.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. Throughout the specification, like reference numerals in the drawings denote like elements.

Embodiments of the invention are described herein with reference to plan and cross-section illustrations that are schematic illustrations of idealized embodiments of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For convenience of explanation, a liquid crystal display device including pixel electrodes patterned with microelectrodes, each pixel electrode being divided into sub-pixel electrodes will be described as an example. However, the liquid crystal display device to which the technical idea of the present invention can be applied is not limited thereto. For example, the present invention may be applied to a liquid crystal display device having a patterned vertical alignment (PVA) structure in which one pixel region includes several domain division units, or a structure in which pixel electrodes are not patterned, and a liquid crystal display device having pixel electrodes which are not divided into sub-pixel electrodes.

Hereinafter, a liquid crystal display device in accordance with an embodiment of the present invention will be described in detail with reference to the accompanying drawings.

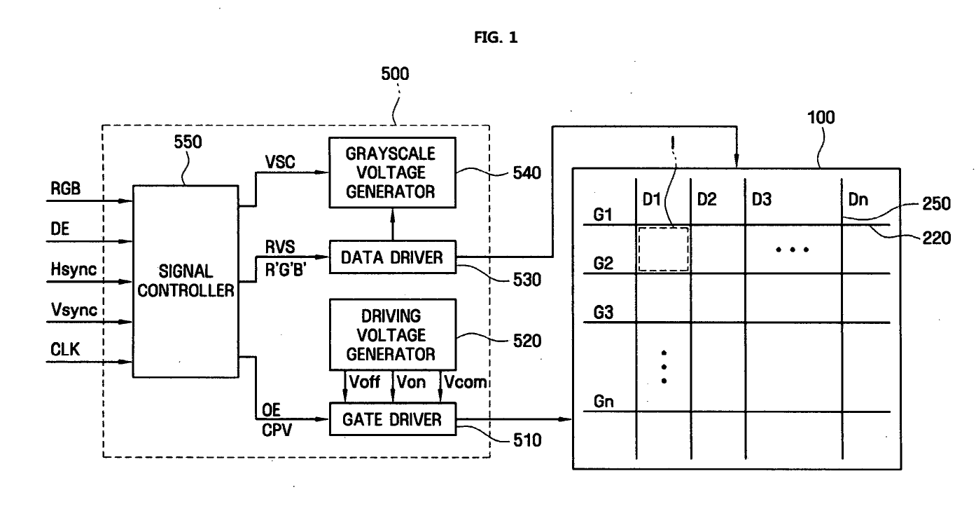

FIG. 1 is a block diagram showing a display device in accordance with embodiments of the present invention.

The liquid crystal display device in accordance with the embodiments of the present invention may include a display panel 100 and a panel driving unit 500. A plurality of pixels I may be arranged in a matrix on the display panel 100. The display panel 100 is, e.g., a liquid crystal panel that may include a first display substrate, a second display substrate and a liquid crystal layer interposed between the two display substrates. The panel driving unit 500 may include a gate driving unit 510, a driving voltage generation unit 520, a data driving unit 530, a gradation voltage generation unit 540, and a signal control unit 550 for driving the above-mentioned units.

The driving voltage generation unit 520 may generate a gate-on voltage Von for turning on switching elements T1, T2 and Tc, a gate-off voltage Voff for turning off the switching elements T1, T2 and Tc, a common voltage Vcom to be applied to a common electrode, and the like. The gradation voltage generation unit 540 may generate a plurality of gradation voltages relating to the luminance of the display device.

The gate driving unit 510 may be connected to gate lines G1 to Gm to apply a gate signal, which is generated by combination of the gate-on voltage Von and the gate-off voltage Voff, and which is supplied from the driving voltage generation unit 520 to the gate lines G1 to Gm.

The data driving unit 530 may select a specific gradation voltage among the gradation voltages applied from the gradation voltage generation unit 540 according to the operation of the signal control unit 550, and apply the selected gradation voltage to particular data lines.

The signal control unit 550 may be provided with RGB signals R, G and B, an input control signal for controlling them, e.g., a vertical synchronizing signal Vsync and a horizontal synchronizing signal Hsync, a main clock signal CLK, a data enable signal DE and the like. These signals may be supplied by an external source, such as an external graphic controller. The signal control unit 550 may generate a gate control signal, a data control signal and a voltage selection control signal VSC based on the input control signal. The gate control signal may include a vertical synchronization start signal STV for instructing an output start of a gate-on pulse (high section of the gate signal), a gate clock signal for controlling an output period of the gate-on pulse, a gate-on enable signal OE for defining a width of the gate-on pulse, and the like. The data control signal may include a horizontal synchronization start signal STH for instructing an input start of a gradation signal, a load signal LOAD or TP for applying a corresponding data voltage to the data lines, an inversion driving signal RVS for inverting the polarity of the data voltage, a data clock signal HCLK, and the like.

The pixels I are minimum units of basic colors independently representing colors, generally, red, blue and green colors. For example, the pixels I may be defined as regions surrounded by data lines and gate lines, but the invention is not limited thereto. In some other embodiments, the pixels may be defined as regions surrounded by data lines and storage lines, or gate lines and storage lines.

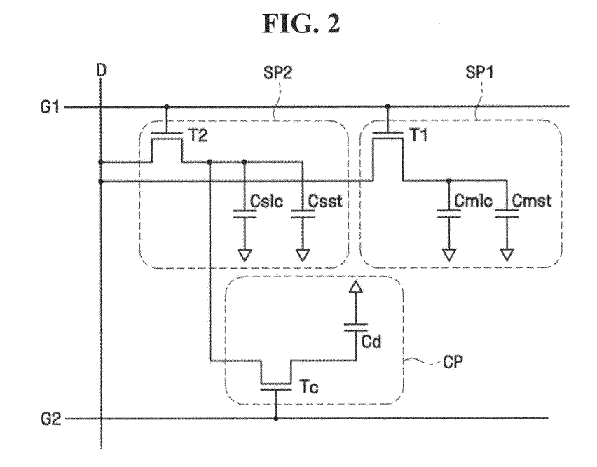

FIG. 2 illustrates an equivalent circuit diagram of the pixel I used in a display substrate in accordance with an embodiment of the present invention.

Referring to FIG. 2, the pixel I is connected to a first gate line G1, a second gate line G2 and a data line D. The pixel I includes a first sub-pixel SP1, a second sub-pixel SP2, and a controller CP. The first and second gate lines G1 and G2 are arranged adjacent to each other. The second gate line G2 may be a next gate line which is disposed next to the first gate line G1. That is, after a gate voltage is applied to the first gate line G1, a gate voltage may then be applied to the second gate line G2. Although the first gate line and the second gate line are sequentially arranged in the drawings, this is merely exemplary. For example, the second gate line may be positioned two or more next gate lines away with respect to the first gate line, or may be a gate line exclusively used to control the third switching element Tc.

The first sub-pixel SP1 includes a first liquid crystal capacitor Cmlc, a first storage capacitor Cmst, and a first switching element T1. In this case, a control terminal of the first switching element T1 is connected to the first gate line G1, and an input terminal of the first switching element T1 is connected to the data line D. Further, an output terminal of the first switching element T1 is connected to terminals of the first liquid crystal capacitor Cmlc and the first storage capacitor Cmst.

The second sub-pixel SP2 includes a second liquid crystal capacitor Cslc, a second storage capacitor Csst, and a second switching element T2. In this case, a control terminal of the second switching element T2 is connected to the first gate line G1, and an input terminal of the second switching element T2 is connected to the data line D. Further, an output terminal of the second switching element T2 is connected to terminals of the second liquid crystal capacitor Cslc and the second storage capacitor Csst, as well as to an input terminal of a third switching element Tc of controller CP.

The controller CP includes a control capacitor Cd and a third switching element Tc. In this case, a control terminal of the third switching element Tc is connected to the second gate line G2, and an input terminal of the third switching element Tc is connected to the output terminal of the second switching element T2. Further, an output terminal of the third switching element Tc is connected to a terminal of the control capacitor Cd. Accordingly, the third switching element Tc is turned on when a gate voltage is applied to the second gate line G2, and the second liquid crystal capacitor Cslc, the second storage capacitor Csst and the control capacitor Cd share charges with each other. Accordingly, the voltage charged into the second liquid crystal capacitor Cslc is (typically) changed.

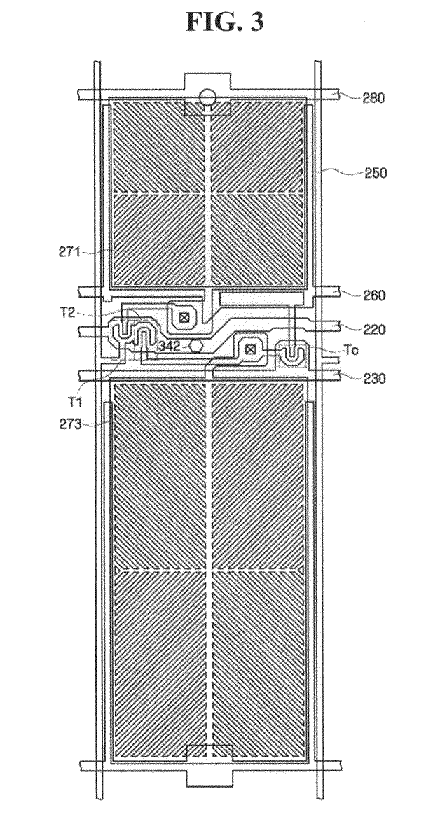

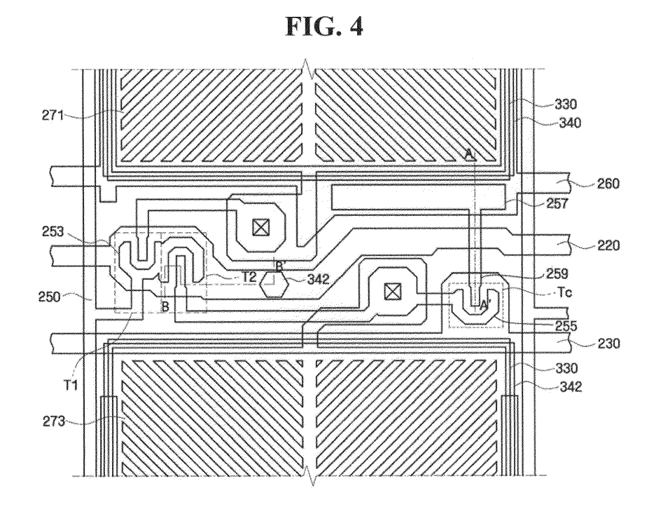

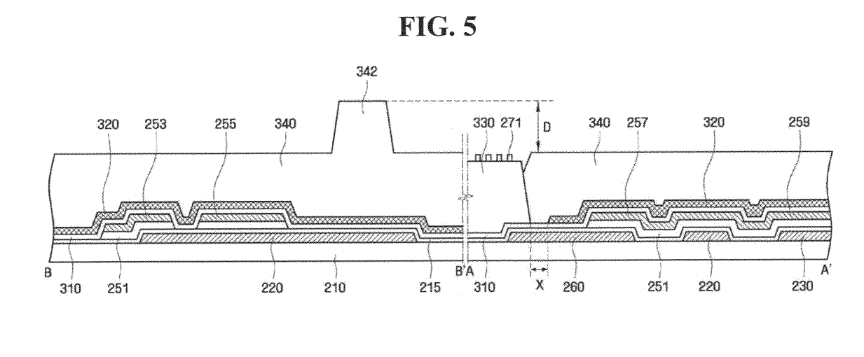

FIG. 3 illustrates a layout of a liquid crystal display device in accordance with this embodiment of the present invention. FIG. 4 shows a partially enlarged view showing further details of the arrangement of the black matrix pattern and color filters of FIG. 3. FIG. 5 is a cross sectional view taken along lines A-A′ and B-B′ of FIG. 4.

Referring to FIGS. 3 to 5, as described above, the pixel I includes three switching elements T1, T2 and Tc. The first switching element T1 drives a first sub-pixel electrode 271, and the second switching element T2 drives a second sub-pixel electrode 273. The third switching element Tc changes a voltage applied to the second sub-pixel electrode 273. In other words, the first switching element T1 is electrically connected to the first sub-pixel electrode 271, and the second switching element T2 is electrically connected to the second sub-pixel electrode 273. Further, the third switching element Tc is electrically connected to a coupling electrode 257.

Although not shown specifically in the drawings, a liquid crystal display device in accordance with this embodiment of the present invention may include a first display substrate 200 including the pixel electrodes 271 and 273, a second display substrate (not shown) facing the first display substrate 200 and including a common electrode (not shown), and a liquid crystal layer (not shown) interposed between the first display substrate 200 and the second display substrate.

The first display substrate 200 may include a first gate line 220, a second gate line 230, a first storage line 260 and a second storage line 280, which are formed on a first substrate 210. The substrate 210 may be formed of, e.g., a glass such as soda lime glass and borosilicate glass, or a plastic.

The first gate line 220, the second gate line 230, the first storage line 260 and the second storage line 280 may be separated from each other and may each generally extend in a first direction, e.g., a horizontal direction. As shown in FIG. 3, the first storage line 260 and the second storage line 280 may overlap with the first sub-pixel electrode 271 and the second sub-pixel electrode 273, respectively, to form a capacitor. In this case, different voltages may be applied to the first storage line 260 and the second storage line 280.

As shown in FIG. 4, the first gate line 220, the second gate line 230, the first storage line 260 and the second storage line 280 may be formed at the same level. In this case, “being formed at the same level” may mean being formed of the same material through the same step. Accordingly, the first gate line 220, the second gate line 230, the first storage line 260 and the second storage line 280 may be formed of the same material. However, in other embodiments, they may be formed at different levels. For example, an insulating layer may be interposed between the first gate line 220 and the second storage line 280.

In some embodiments, the first gate line 220, the second gate line 230, the first storage line 260 and the second storage line 280 may be commonly referred to as signal lines.

As shown in FIG. 3, the first gate line 220, the second gate line 230 and the first storage line 260 may be arranged generally between the first sub-pixel electrode 271 and the second sub-pixel electrode 273. In other words, the first gate line 220, the second gate line 230 and the first storage line 260 may be separated from and adjacent to each other, and the first sub-pixel electrode 271 may be arranged generally between the second storage line 280 and the lines 220, 230 and 260. In another aspect, the second sub-pixel electrode 273 may be arranged generally between the second storage line 280 and a region where the first gate line 220, the second gate line 230 and the first storage line 260 are formed.

As described above, since the first storage line 260 is formed separately from the second storage line 280, they may extend while being separated (i.e., electrically insulated) from each other. Further, different voltages may be applied to the first storage line 260 and the second storage line 280.

A gate insulating layer 215 is formed on the substrate 210 to cover the first gate line 220, the second gate line 230, the first storage line 260 and the second storage line 280. The gate insulating layer 215 may be formed of an inorganic insulating material such as silicon oxide (SiOx), benzocyclobutene (BCB), an acrylic material and an organic insulating material such as polyimide.

A semiconductor layer 251, made of a semiconductor such as hydrogenated amorphous silicon, is formed on the gate insulating layer 215 on the gate electrode of the first gate line 220. Further, although not shown in the drawings, a resistance contact layer (not shown) may be formed on the semiconductor layer 251. This resistance contact layer may be made of a material such as silicide or n+ hydrogenated amorphous silicon doped with n type impurities in high concentration.

A data wiring 250, 253, 255, 257 and 259 is formed on the gate insulating layer 215 and the semiconductor layer 251. For example, the data wiring 250, 253, 255, 257 and 259 may have a single layer or multilayer structure of metal.

The data wiring 250, 253, 255, 257 and 259 may include a data line 250 formed in a vertical direction to intersect the first gate line 220, the second gate line 230 and the second storage line 280, thereby defining the pixel I, and source or drain electrodes 253 and 255. Further, the data wiring 250, 253, 255, 257 and 259 may include the coupling electrode 257 which at least partially overlaps with the first storage line 260 to form the control capacitor Cd. The invention contemplates any at least partially overlapping shapes for coupling electrode 257 and first storage line 260.

More specifically, the data wiring 250, 253, 255, 257 and 259, along with the first gate line 220 and the second gate line 230, may together form the first to third switching elements T1, T2 and Tc.

The first switching element T1 may include a first source electrode 253 which at least partially overlaps with the first gate line 220 and which is connected to the data line 250, as well as a first drain electrode which at least partially overlaps with the first gate line 220 and which is separated from the first source electrode 253. The second switching element T2 may include a second source electrode 253 which is connected to the first source electrode 253 and which at least partially overlaps with the first gate line 220, and a second drain electrode 255 which at least partially overlaps with the first gate line 220 and which is separated from the second source electrode 253. Similarly, the third switching element Tc may include a third source electrode 255 which is connected to the second drain electrode 255 and which at least partially overlaps with the second gate line 230, and a third drain electrode 259 which at least partially overlaps with the second gate line 230 and which is separated from the third source electrode 255.

When a first gate signal is applied through the first gate line 220, the first switching element T1 and the second switching element T2 are switched on. Similarly, when a second gate signal is applied through the second gate line 230, the third switching element Tc is switched on. As described above, when the third switching element Tc is turned on by the second gate signal, the voltage charged in the second liquid crystal capacitor Cslc may be changed.

The first drain electrode may be electrically connected to the first sub-pixel electrode 271 via a contact hole. The second drain electrode 255 may be electrically connected to the second sub-pixel electrode 273 via a contact hole. In order to stably achieve these electrical connections, as shown in the drawings, the first sub-pixel electrode 271 and the second sub-pixel electrode 273 may include extension portions, respectively, and the first drain electrode and the second drain electrode 255 may also include extension portions, respectively.

A passivation layer 310 may be formed on the data wiring 250, 253, 255, 257 and 259. The passivation layer 310 may be formed of, e.g., an organic film, an inorganic film or multiple organic and/or inorganic films. For example, although not shown in the drawings, the passivation layer 310 may include an inorganic film formed conformally along profiles of the data wiring 250, 253, 255, 257 and 259 and the gate insulating layer 215, and an organic film formed on the inorganic film. The organic film may be formed of a material having desirable planarization characteristics.

The pixel electrodes 271 and 273 may be formed on the passivation layer 310. The pixel electrodes 271 and 273 may be generally formed of a transparent conductive material such as indium tin oxide (ITO) or indium zinc oxide (IZO). The pixel electrodes 271 and 273 may include the first sub-pixel electrode 271 electrically connected to the first drain electrode, and the second sub-pixel electrode 273 electrically connected to the second drain electrode 255. As shown in the drawings, the first and second sub-pixel electrodes 271 and 273 may include a slit pattern.

As described above, an overlapping region between the coupling electrode 257 and the first storage line 260 may form the control capacitor Cd. That is, the overlapping region may reduce a charging voltage of the second sub-pixel electrode 273. In this case, the capacitance of the control capacitor Cd may be adjusted by adjusting a voltage applied to the first storage line 260.

As shown in FIGS. 3 and 4, the first storage line 260 may be formed to have an extended area at a region overlapping with the coupling electrode 257. An extension portion of the first storage line 260 is formed at the overlapping region between the coupling electrode 257 and the first storage line 260, so as to form the control capacitor Cd together with the coupling electrode 257. This capacitor Cd reduces a charging voltage of the second sub-pixel electrode 273.

Further, the first storage line 260 may be formed separately from the second storage line 280. That is, the first storage line 260 and the second storage line 280 may be physically and electrically separated or isolated from each other. Accordingly, different voltages may be applied to the first storage line 260 and the second storage line 280. Although not shown in the drawings, the first storage line 260 and the second storage line 280 may be formed in a circuit unit (not shown) of the display panel 100, and be respectively connected to first and second voltage lines for applying different voltages, so that different voltages can be applied to the first storage line 260 and the second storage line 280.

As shown in FIGS. 4 and 5, the liquid crystal display device in accordance with the embodiment of the present invention includes a signal line, color filters 330 and a black matrix pattern 320.

The signal line is formed on the substrate 210 to extend generally in a first direction. The signal line may be, e.g., the second gate line 230 or the first storage line 260. A case in which the signal line is the first storage line 260 will be described as an example below, but the same principles apply to cases in which the signal line is the second gate line 230.

The color filters 330 may be formed to partially overlap the signal line, e.g., the first storage line 260. Each of the color filters 330 may be formed corresponding to respective ones of the pixels. The pixel regions may be defined by the data lines 250 and the gate lines 220 and 230, and the color filters 330 may be formed in the defined pixel regions.

As shown in FIG. 5, the color filters 330 may be formed on the passivation layer 310 to correspond to regions where the first and second sub-pixel electrodes 271 and 273 are formed. Further, as described above, the color filters 330 may be formed to partially overlap with the first storage lines 260. Additionally, the liquid crystal display device in accordance with this embodiment of the present invention may have a structure in which the color filters 330 are formed on the first substrate 210, i.e. under the switching elements T1, T2, Tc. Further, as will be described below, the black matrix pattern 320 may be also formed on the first substrate 210 together with the color filters 330.

The black matrix pattern 320 is formed separately from the color filters 330. As shown in the figures, the black matrix pattern 320 may be formed on a region other than the pixel regions. In other words, the black matrix pattern 320 may be formed on structures such as the signal lines, e.g., the data line 250, the first gate line 220, the second gate line 230, the first storage line 260 and/or the second storage line 280. The black matrix pattern 320 may serve to prevent leakage of light and to further define the pixel regions.

In this case, the black matrix pattern 320 may be formed on the first substrate 210. Further, the black matrix pattern 320 may include metal such as chromium (Cr), metal oxide such as chromium oxide, an organic black resist, or the like.

As described above, the color filters 330 and the black matrix pattern 320 are formed at least partially on the signal lines. In particular, the color filters 330 and the black matrix pattern 320 partially overlap with the signal lines, and the color filters 330 and the black matrix pattern 320 may be formed separately from each other on the signal lines.

As shown in FIG. 5, the color filters 330 and the black matrix pattern 320 may be separated from each other by a first distance X. In this case, the first distance X may be equal to or smaller than about 4 mm. That is, the color filters 330 and the black matrix pattern 320 may be formed separately from each other by a maximum distance of about 4 μm.

Further, a column spacer pattern 340 may be formed over these separation portions, i.e. locations where the color filters 330 are separated from the black matrix pattern 320 by the first distance X. As shown in FIGS. 4 and 5, the column spacer pattern 340 may include at least one protrusion portion, i.e., a column spacer 342. The column spacer 342 may maintain a distance between the first display substrate and the second display substrate, such that liquid crystal can be more smoothly injected therebetween. For convenience of explanation, a portion of the column spacer pattern 340 other than the column spacer 342, which has a relatively small thickness compared to the column spacer 342, is referred to as a peripheral portion.

Although one column spacer 342 is illustrated in the drawings, the liquid crystal display device may include a plurality of column spacers according to, e.g., the size and purpose thereof. Specifically, the liquid crystal display device in accordance with the embodiment of the present invention may include a plurality of column spacers having different heights, e.g., a main column spacer for maintaining a distance between the first display substrate and the second display substrate, and a subsidiary column spacer having a height smaller than that of the main column spacer to supplement the function of the main column spacer. Accordingly, a first height from the surface of the first substrate to the end of the main column spacer may be larger than a second height from the surface of the first substrate to the end of the subsidiary column spacer. That is, the invention includes embodiments that have column spacers of differing heights, so that different areas of the first and second substrates are maintained at different distances from each other.

Referring again to FIG. 5, the column spacer pattern 340 may be formed on the separation portion between the color filters 330 and the black matrix pattern 320, such that the column spacer pattern 340 is buried in a separation region defined between the color filters 330 and the black matrix pattern 320. In this case, the column spacer pattern 340 may also be formed to partially overlap with the color filters 330.

In other words, the column spacer pattern 340 may cover a separation region defined between the color filters 330 and the black matrix pattern 320. The column spacer pattern 340 may be formed to partially overlap the color filters 330 and to overlap the black matrix pattern 320. In this case, the column spacer pattern 340 may include a colored material to perform a light blocking function.

Further, as shown in the drawings, the column spacer pattern 340 may include at least one column spacer 342 which protrudes from the peripheral portion. As described above, the column spacer 342 may include one or more of both a main column spacer and a subsidiary column spacer.

The height of the column spacer 342 may be larger than the height of the column spacer pattern 340 in the separation region between the color filters 330 and the black matrix pattern 320. That is, the end of the column spacer 342 and the end of the column spacer pattern 340 in the separation region may have a height difference.

For example, if the column spacer 342 is a main column spacer, the height difference between the column spacer 342 and the column spacer pattern 340 in the separation region may be at least approximately 0.7 μM. That is, a minimum value of the height difference may be about 0.7 μm. However, this height difference can take on any suitable value.

For example, if the column spacer 342 is a subsidiary column spacer, the column spacer pattern 340 in the separation region may be formed at a height smaller than that of the column spacer 342.

As described above, in liquid crystal display devices constructed in accordance with embodiments of the present invention, the color filters and the black matrix pattern are formed separate from each other. Accordingly, a region where the color filters and the black matrix pattern are arranged adjacent to each other, but spaced apart by a gap. The column spacer patterns can be placed in this gap, without fully overlapping the color filters, so as to reduce the total height of these layers.

In other words, the color filters and the black matrix pattern are formed separately from each other on the signal lines without overlapping each other, and the column spacer pattern is formed to be buried in the separation region therebetween. Accordingly, the column spacer pattern can be formed to have a smaller height in the separation region, as compared to a case where the color filters and the black matrix pattern are formed to overlap each other on the signal lines.

Thus, the column spacer itself, as well as that portion of the column spacer pattern that lies in the separation region, are each formed to have appropriate heights such that the height difference between the main column spacer and the column spacer pattern in the separation region is, e.g., about 0.7 μm or more, thereby ensuring sufficient clearance for reliable liquid crystal injection.

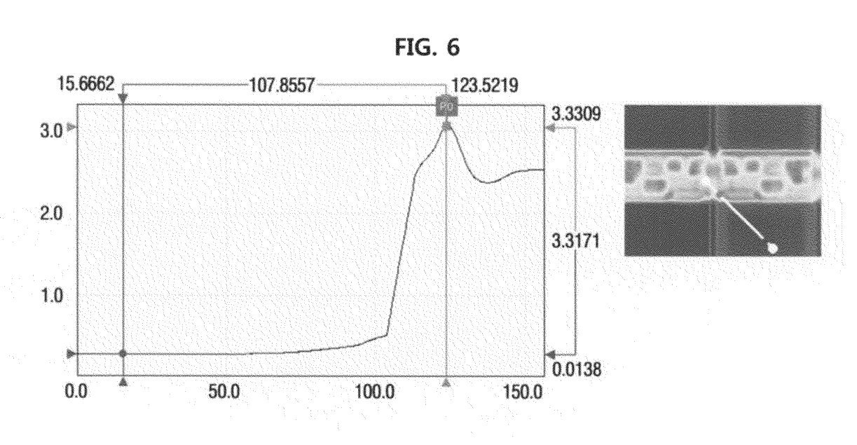

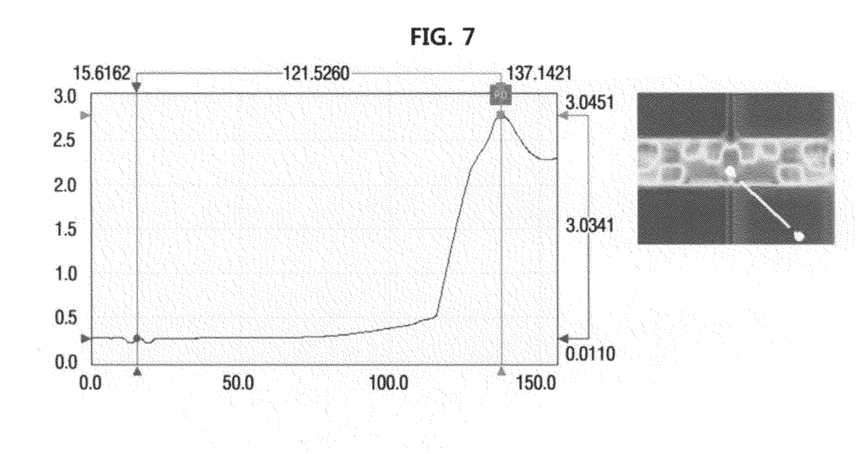

Next, a performance of an embodiment of the invention is compared to a conventional display, with reference to FIGS. 6 and 7. FIG. 6 illustrates a graph and diagram for explaining a height profile in a conventional structure. FIG. 7 illustrates a graph and diagram for explaining a height profile in a structure in accordance with the embodiment of the present invention.

Referring to FIG. 6, a height profile of a pixel unit was measured from the lower right endpoint of the line shown in the photograph on the right of FIG. 6, to the upper left endpoint. Measured heights are illustrated in the graph on the left of FIG. 6. In this case, the height of the main spacer was measured to be 3.71 μm.

As shown in FIG. 6, the height of the region where the color filters and the black matrix pattern are adjacent to each other was measured to be about 3.33 μm. It can thus be seen that the height difference between the main spacer and the region in which the color filters and the black matrix pattern are adjacent to each other is about 0.38 μm.

Referring to FIG. 7, similar to FIG. 6, a height profile of a pixel unit was measured from the lower right endpoint of the line shown in the photograph on the right of FIG. 7, to the upper left endpoint. Measured heights are illustrated in the graph on the left of FIG. 7. In this case, the height of the main spacer was measured to be 3.73 μm.

As shown in FIG. 7, the height of the gap region between the color filters and the black matrix pattern was measured to be 3.043 μm. It can be seen that the height difference between the main spacer and the height of this gap region is about 0.69 μm, almost double the height difference (about 0.38 μm) of FIG. 6.

As described above, a relatively large height difference is formed in the liquid crystal display device in accordance with the embodiment of the present invention, as compared to a conventional structure. Accordingly, it is possible to ensure a larger margin of clearance for liquid crystal injection in the embodiment of the present invention.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

1. A liquid crystal display device comprising:
a signal line formed on a first substrate to extend generally in a first direction;
a color filter at least partially overlapping the signal line;
a black matrix pattern separated from the color filter by a separation region; and
a column spacer pattern formed on the separation region.

2. The liquid crystal display device of claim 1, wherein the column spacer pattern includes a colored material to block light.

3. The liquid crystal display device of claim 1, wherein the column spacer pattern at least partially overlaps the color filter.

4. The liquid crystal display device of claim 1, wherein the column spacer pattern is formed on the black matrix pattern.

5. The liquid crystal display device of claim 1, further comprising a second substrate facing the first substrate; and
a liquid crystal layer interposed between the first substrate and the second substrate.

6. The liquid crystal display device of claim 5, wherein the color filter and the black matrix pattern are arranged on the first substrate.

7. The liquid crystal display device of claim 5, wherein:
the column spacer pattern includes a peripheral portion and a first column spacer protruding from the peripheral portion, and
a height of the first column spacer is larger than a height of the column spacer pattern that lies on the separation region.

8. The liquid crystal display device of claim 7, wherein the height of the first column spacer is at least about 7 μm larger than the height of the column spacer pattern that lies on the separation region.

9. The liquid crystal display device of claim 1, wherein:
the black matrix pattern at least partially overlaps the signal line, and the color filter and the black matrix pattern do not overlap each other.

10. The liquid crystal display device of claim 1, wherein the color filter is separated from the black matrix pattern by a first distance that is generally equal to or smaller than about 4 μm.

11. The liquid crystal display device of claim 1, further comprising a pixel electrode formed on the color filter,
wherein the pixel electrode comprises a negative organic film.
